(19) United States
(12) Patent Application Publication
(10) Pub. No.: US 2009/0000796 A1
(43) Pub. Date: Jan. 1, 2009

(54) ADJUSTABLE SCRAPER BLADE SYSTEM FOR DISK HARROWS

(76) Inventors: Troy L. Cooper, Goodfield, IL (US); Rickey Gerber, Roanoke, IL (US); Gaylen J. Kromminga, Morton, IL (US); Scott Faust, Philo, IL (US)

Correspondence Address: CNH AMERICA LLC, INTELLECTUAL PROPERTY LAW DEPARTMENT, 700 STATE STREET, RACINE, WI, 53404, US

(21) Appl. No.: 11/769,380

(22) Filed: Jun. 27, 2007

(51) Int. Cl. A01B 23/06

(52) U.S. Cl. 172/563; 172/558

(57) ABSTRACT

An adjustable scraper blade system for use with disk harrow implements is provided. The adjustable scraper blade system includes a mounting bracket secured at one end to the harrow implement, a scraper blade, and fasteners for selectively fixing the scraper blade in position. The scraper blade includes an arcuate scraping edge and an anchoring aperture defining an axis of pivotation of the scraper blade. It further includes an elongate adjustment slot that defines a range of arcuate adjustment of the scraper blade. The adjustability features of the adjustable scraper blade system facilitate alignment of the scraper blade so its scraping edge can be fixed in aligned face-to-face registration with the disk blade concave surface defining a clearance or gap therebetween of generally constant width.

### FIELD OF THE INVENTION

The invention relates generally to a scraper blade system for a disk configuration of an agricultural implement, and more specifically, to an adjustable scraper blade system for use with disk harrows. The adjustable scraper blade system is selectively movable with respect to a disk blade within a disk gang of the disk harrow. This configuration deflects soil, dirt, or debris, and prevents it from accumulating between adjacent disk blades of the disk gang.

### BACKGROUND OF THE INVENTION

Agricultural soil preparation equipment typically includes a disk configuration commonly referred to as a disk or disk harrow, to be used for breaking up and smoothing the surface of cultivated fields in preparation for planting. In addition to planting preparation, disk harrows are increasing in popularity as a necessary implement for crop residue management. Modern plant varieties produce relatively higher yields, are physically and structurally tougher, and leave behind relatively more residue than previous plant varieties. The disk harrow is usually drawn by a tractor or other source of motor power; multiple disk gangs are often employed in a single disk harrow. In disk harrows which incorporate multiple disk gangs, a forward disk gang initially cuts residue or breaks up lumps and clods, and a rear disk gang reduces the residue of dirt fragments to a still smaller size and smoothes the ground. Accordingly, the residue is reduced in size and mixed with the dirt or soil, which increases its decomposition or breakdown rate.

Typical disk harrows include a main frame with several disk gang assemblies suspended therefrom. The disk gangs are generally mounted at an angle with respect to the forward direction of travel. Each of the disk gangs includes a plurality of equally spaced disk blades mounted on an axle for rotation about a common axis. The axle is supported by a series of elongate bearing hangers or standards. The bearing standards support bearing assemblies, which rotatably support the axle. The bearing standards span between and connect the axle to an overlying horizontal tubular member, commonly referred to as a toolbar.

In wet weather or in heavy, sticky, soil conditions, earth tends to cling to the disk blades. In order to smooth the ground properly, it is desirable that this earth be removed frequently or even continuously. Otherwise the accumulation of soil and residue adhering to the disks can adversely affect disk operation. To eliminate the accumulation of soil and residue, scraper devices have been developed to keep the surfaces of the disks, near their circumferences, clear of the soil and residue.

U.S. Pat. No. 4,127,179 discloses a scraper mechanism for a disk gang harrow. The scraper mechanism includes a scraper blade supported from a mounting bracket fixedly attached to a toolbar of an agricultural implement to be towed. The scraper blade is generally aligned in a downward direction so as to bias against the disk blade. An axle of the disk gang passes through bearing assemblies which are suspended and supported by bearing-support arms that extend down from the toolbar and are rigidly supported therefrom.

As shown and described in co-pending and commonly assigned U.S. application Ser. No. 11/096,400, filed on Apr. 1, 2005 and published on Oct. 12, 2006 as U.S. publication number 2006/0225901, entitled DISC BLADE SCRAPER SYSTEM, other disk scraping configurations have been developed, including various ones with scraper blades mounted to elongate brackets which do not provide enclosure-type protection for bearing assemblies.

However, known disk scraping configurations have limited or no adjustability of the scraping blades, at the intersections of the blades and their mounting brackets. Thus, such known disk scraping configurations offer limited or no alignment, orientation, or positional versatility, at the intersections of the blades and their mounting brackets. Correspondingly, there can be non-desirable gaps between scraper blades and respective disk blades. If the gaps are sufficiently large, during use of the disk harrow, soil and residue flow can be forced between the scraper blades and disk blade, which can push or otherwise force the scraper blades away from the disk blades.

When the scraper blades are forced away from the disk blades, their scraping utility and functionality can be greatly reduced. Furthermore, the mounting bracket, scraper blade, or corresponding hardware can break or otherwise fail. This permits soil and residue flow to be carried from the rear of the rotating blades up and forward over the top of the disk gang spools. The soil and residue can become trapped behind the disk gang bearing standards, on the top of the gang bearing assemblies, and/or between adjacent disks. When this happens, the soil and residue mixture can be compacted between the disk blades and the standard, and prevent the proper operation of the disk gang.

### SUMMARY OF THE INVENTION

There is a need for an adjustable scraper blade system offering greater mobility for alignment during installation on and maintenance of a disk harrow. There is also a need for an adjustable scraper blade system which offers greater versatility for realigning, fine-tuning, correcting, and/or otherwise modifying the alignment of the scraper blades with the disk blades.

The present invention provides an adjustable scraper blade system that meets the desires and needs described above, while being used, e.g., in combination with a disk gang of an agricultural implement. In a first embodiment of the present invention, an adjustable scraper blade system for use with a disk harrow is provided for facilitating alignment of a scraper disk with a disk blade. The system also provides a scraper blade attached to a mounting bracket and having a leading edge, a trailing edge, and an arcuate scraping edge extending between and connecting the leading and trailing edges. The scraper blade can be moveable with respect to the mounting member, permitting angular alignment of the scraping edge with a concave surface of the disk blade.

It is contemplated for the scraper blade to have an elongate adjustment slot extending angularly between leading and trailing edges of the scraper blade. This adjustment slot can extend generally transverse to the length of the harrow axle, when assembled. In this configuration, the adjustment slot can extend toward a point of intersection of a top edge and the trailing edge of the scraper blade.

In still further implementations, the scraper blade has an elongate adjustment slot and an anchoring aperture. The anchoring aperture defines a generally round or circular perimeter shape and is located between the adjustment slot and the scraping edge. It is contemplated that the scraping edges of the scraping disks have radii that correspond closely to radii of respective disk blade concave surfaces. Correspondingly, when a scraper blade is suitably positioned with respect to the disk blade, the scraping edge can be aligned in face-to-face registration with the concave surface. In this configuration, the scraping edge and the concave surface define an elongate clearance or gap with a generally constant width opening dimension along its entire length.

Other objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 illustrates a detailed rearward isometric view of a first embodiment of an adjustable scraper blade assembly in accordance with the present invention, incorporated on a disk gang having rigid bearing standards.

FIG. 2 illustrates a side elevational view of the adjustable scraper blade assembly shown in FIG. 1, incorporated on a disk gang having cushion bearing standards.

FIG. 3 illustrates a front elevational view of a scraper blade used in the adjustable scraper blade system of FIG. 1.

FIG. 4 illustrates a cross-sectional view of a disk blade and a front elevation of the adjustable scraper blade system taken at line 4-4 of FIG. 3.

FIG. 5 illustrates the adjustable scraper blade system of FIG. 4, with the scraper blade and disk blade having a non-uniform clearance or gap therebetween.

### DETAILED DESCRIPTION OF THE PREFERRED EMBODIMENTS

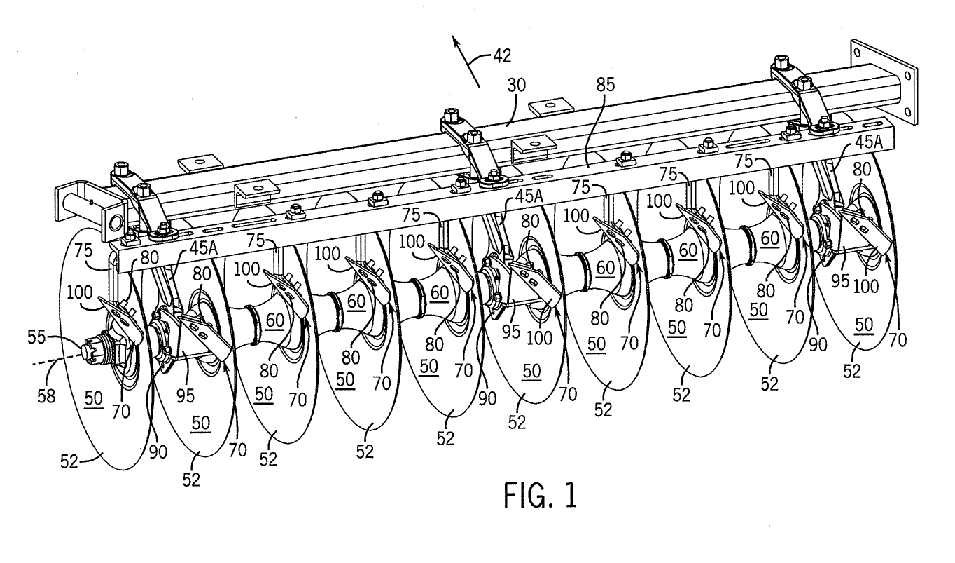

FIG. 1 shows a first embodiment of an adjustable scraper blade system; namely, scraper blade system 70, employed on a disk gang 40. A tube or toolbar 30 is part of, and pivotably mounts the disk gang 40 to, an agricultural tillage or soil-working implement (not illustrated). The agricultural implement includes a toolbar 30 which supports one or more disk gangs 40 that are operable to cut and reduce the size of residue, or to break up lumps, clods, or soil to smaller sized fragments for residue management or for smoothing the ground.

Although no specific agricultural implement is illustrated, it is well understood that disk gang 40 can be incorporated into any of a variety of suitable disk harrows or other implements. Numerous suitable disk harrows include various ones manufactured by CNH America LLC, such as the Case IH model RMX370 Tandem Disks, and others.

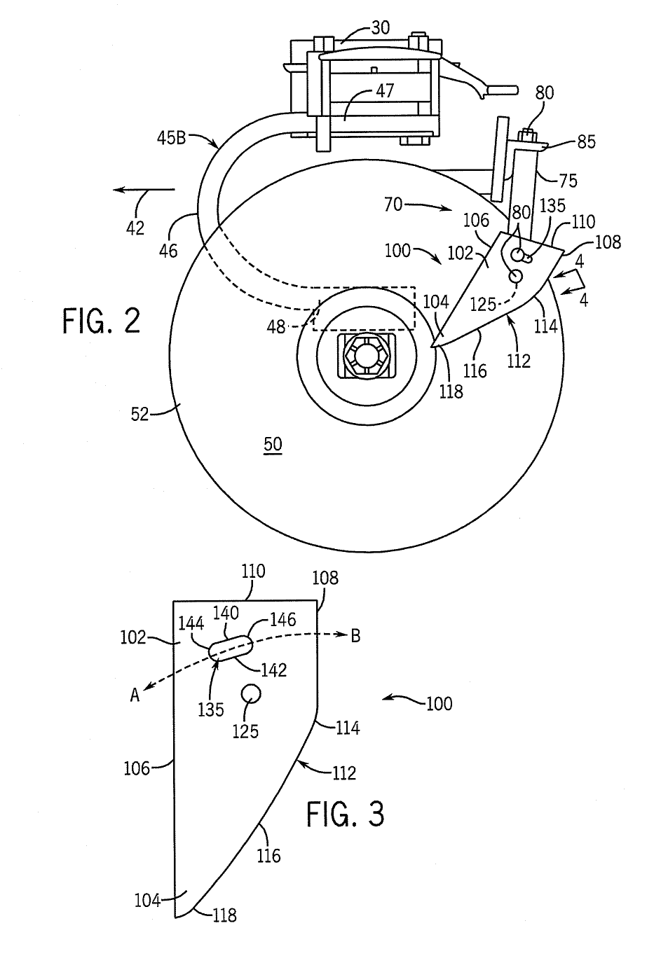

The one or more disk gangs 40 are supported from the toolbar 30 so as to be to be towed in a forward direction, illustrated by the reference arrow 42, over the soil where crop residue or other material is present. The disk gang 40 is attached to the toolbar 30 of the agricultural implement by one or more elongate bearing hangers such as rigid standards 45A (FIG. 1), or cushion standards 45B (FIG. 2).

Referring now to FIG. 1, the rigid standards 45A are configured in a convention manner to rigidly support the disk gang 40 from the toolbar 30. Each of the rigid standards 45A is preferably a solid cast-iron component, optionally a steel tubular member. The upper ends of the rigid standards 45A clamp to or are otherwise suitably attached to the toolbar 30. The lower ends of the rigid standards 45A attach, directly or indirectly, to conventional bearing assemblies 90.

Referring now to FIG. 2, other configurations of implement 25 are considered, such as those configured in a conventional manner to resiliently support the disk gang 40 from the toolbar 30, by way of cushion standard 45B. The cushion standards 45B include C-shaped spring elements 46 having generally planar upper and lower portions 48, respectively. The upper portions 47 of cushion standards 45B clamp to or are otherwise suitably attached to the toolbar 30. The lower portions 48 of cushion standard 45B attach, directly or indirectly, to conventional bearing assemblies 90.

Referring again to FIG. 1, the preferred disk gang 40 generally includes a series of transversely spaced disk blades 50 mounted for rotation in unison on a common axle 55 extending generally parallel to the toolbar 30. The common axle 55 is rotatably housed within the bearing assemblies 90, and defines and rotates about axis 58. The series of disk blades 50 are slidably spaced apart from one another by conventional sleeves or spools 60 along the common axle 55. The spools 60, in combination with bearing assemblies 90, rotatably support the disk gang 40 on the common axle 55. As the toolbar 30 and disk gang 40 are moved in the forward direction 42 through the soil, the disk gang 40 is operable in a conventional manner to cut and mix residue, break-up lumps and clods of soil and debris to reduce fragments to still smaller-size, and to mix and smooth the soil surface in, e.g., preparation for planting or for residue management.

During use, dirt, earth, and residue tend to build up or accumulate on the surfaces of the disk gang 40 between the individual disk blades 50. This dirt, earth, and residue must be removed to maintain good operation of the disk gang 40 in properly working the soil and/or in residue reduction practices. To prevent or mitigate this, adjustable blade assemblies 70 are provided.

Between adjacent pairs of disk blades 50, along the length of axle 55, accumulating dirt and debris is removed by adjustable scraper blade assemblies 70. Each adjustable scraper blade assembly 70 includes a mounting structure or mounting bracket, such as arm member 75, various fasteners 80, and scraper blade 100. The adjustable scraper blade assemblies provide lateral adjustability or radial adjustability facilitating alignment of the scraper blade 100 and disk blade 50, such that lines extending normal to, or perpendicularly from, their respective facing surfaces are generally parallel to each other when the disk and scraper blades 50, 100 are properly aligned.

The arm member 75 includes a linear elongated metallic piece comprised of spring steel or other appropriate material operable to bias the scraper blade 100 against the surface of the disk blade 50. Fasteners 80 attach a first end of the arm member 75 to toolbar 30 or by way of a mounting bracket 85 that extends generally parallel to the axle 55.

Scraper arm member 75 is configured to support and bias the scraper blade 100 against the surface of the disk blade 50. This alignment of the scraper arm member 75 holds the scraper blade 100 above the spool 60 in a manner that enhances removal of soil and debris attached to the disk blade 50. This alignment and location of the scraper arm member 75 also places the scraper blade 100 above the spool 60 at a location out of the primary soil flow path, minimizing the potential for damage to the scraper arm member 75 and the scraper blade 100. The preferred scraper arm member 75 generally includes a linear elongated metallic piece comprised of spring steel or other appropriate material operable to maintain a bias of the scraper blade 100 against the disk blade 50.

Optionally, the scraper blades 100 can be attached to the disc gang 40 by other mounting brackets or structures, e.g., brackets extending from the bearing assemblies 90, shown and described in co-pending and commonly assigned U.S. application Ser. No. 11/742,236, filed on Apr. 30, 2007, entitled CUSHION STANDARD SHIELD SYSTEM; optionally from the bearing shield members 95 (FIG. 1) shown and described in co-pending and commonly assigned U.S. application Ser. No. 11/742,260, filed on Apr. 30, 2007, entitled RIGID STANDARD BEARING SHIELD DISK SCRAPER SYSTEM.

Regardless of the particular method of mounting the scraper blade 100 to disc gang 40, the scraper blades 100 are generally mounted at an angle to effect a scraping action on the concave sides or surfaces 52 of the disk blades 50 in a conventional manner. The location of the scraper blade 100 relative to the respective disk blade 50 is, in general, identical for each of the series of disk blades 50 of the disk gang 40.

Referring now to FIGS. 1 and 3, scraper blade 100 is a generally planar paddle, e.g., a plate-like member, with upper portion 102 and lower portion 104. Leading edge 106 extends along the entire length of the scraper blade 100 and faces toward the travel direction 42. Trailing edge 108 faces away from the travel direction 42, is generally parallel to the leading edge 106, and defines the rearward most portion of the scraper blade 100. Top edge 110 defines the top of upper portion 102 and extends along a generally perpendicular path between the leading and trailing edges 106, 108.

A scraping edge 112 extends arcuately, as a convex arc or bow, between the lowermost ends of leading edge 106 and trailing edge 108. The radii of scraping edges 112 correspond closely to the radii of the concave surfaces 52 of disk blades 50. In this configuration, when the scraping edge 112 is aligned in face-to-face registration with the concave surface 52, the edge and surface define a clearance or gap having a generally constant width along its entire length.

Scraping edge 112 defines three portions thereof. More specifically, scraping edge 112, has a heal segment 114, a crest segment 116, and a toe segment 118. The heal segment 114 is defined adjacent the trailing edge 108. The crest segment 116 extends from the end of the heal segment 114, to the toe segment 118 which is adjacent the leading edge 106. Stated another way, heal segment 114 intersects trailing edge 108, toe segment 118 intersects leading edge 106, and crest 116 spans between the heal and toe segments 114 and 118, respectively, all of which in combination define the scraping edge 112.

Anchoring aperture 125 and adjustment slot 135 cooperate with fasteners 80 and scraper arm member 75, or other mounting structure(s) of the disc gang 40. In particular, anchoring aperture 125 and adjustment slot 135 are adapted and configured to adjustably mount the scraper blade 100 to the disc gang 40.

Anchoring aperture 125 extends through the entire thickness dimension of scraper blade 100, at the upper portion 102. A fastener 80 extends axially through the anchoring aperture 125 securing it to scraper arm member 75. The anchor aperture 125 is preferably a circular throughbore such that it concentrically houses the fastener 80, whereby the inner circumferential wall of anchor aperture 125 can rotatably slide with respect to an outer circumferential wall of fastener 80. In such configuration, the fastener 80 serves as a pivot pin and defines an axis of pivotation for the scraper blade 100. Likewise, the anchoring aperture 125 serves as a hinge socket that restricts the movement of scraper blade 100 to pivotation about fastener 80, when it extends therethrough.

As best seen in FIG. 3, adjustment slot 135, like anchoring aperture 125, extends through the entire thickness dimension of the scraper blade 100 upper portion 102. However, adjustment slot 135 is an elongate opening, unlike the generally circular throughbore configuration of anchoring aperture 125. Upper and lower elongate slot walls 140, 142 are parallel to each other and define opposing upper and lower edges of the adjustment slot 135. The upper and lower slot walls 140 and 142, respectively, can be either straight-line linear, or curvilinear and arcuate, as desired. Slot leading endwall 144 extends between and connects the first ends of upper and lower slot walls 140 and 142, respectively, proximate the leading edge 106. The other ends of upper and lower slot walls 140 and 142, respectively, are connected to each other by slot trailing endwall 146.

Upper and lower slot walls 140 and 142, respectively, extend generally angularly with respect to the leading edge 106, the trailing edge 108, and the top edge 110 of the scraper blade 100. This angular orientation of the upper and lower slot walls 140, 142 contributes to defining the, e.g., pivotation path for adjusting the alignment of scraper blade 100 with respect to the disks 50. Accordingly, a first end of the adjustment slot 135 can extend generally toward a point of intersection of the top and trailing edges 108, 110. A second end of the adjustment slot 135 can extend generally toward a medial portion of the leading edge.

Accordingly, the size, shape, position, relative dimensions, orientation, and/or other configurations of (i) the adjustment slot 135, (ii) anchoring aperture 125, (iii) scraping edge 112, and (iv) fasteners 80, all contribute, at least to some extent, to the adjustability characteristics of the scraper blade 100. The scraper blade can be movable along the length of axle 55 in a conventional manner, while the anchoring aperture 125 and adjustment slot 135, and/or other components of adjustable scraper blade assembly 70, e.g., facilitate angular movement of scraper blade 100 about an axis extending generally perpendicular to axle 55.

As influenced at least partially by the relative dimensions of the features of scraper blade 100, during a pivoting adjustment whereby the fastener 80 slides within adjustment slot 135, the distance that the scraping edge 112 travels varies along the length thereof. As the fastener 80 slides a given length through adjustment slot 135, discrete points along the length of scraping edge 112 travel different distances, depending on their particular radial distances from the axis of pivotation, namely, anchoring aperture 125.

Points along the scraping edge 112 that are located relatively further from the anchoring aperture 125, such as points within the toe segment 118, travel relatively further during a pivoting adjustment manipulation. Correspondingly, points of scraping edge 112 that are located relatively nearer the anchoring aperture 125, such as points within the heal segment 114, travel relatively less far during a pivoting adjustment manipulation.

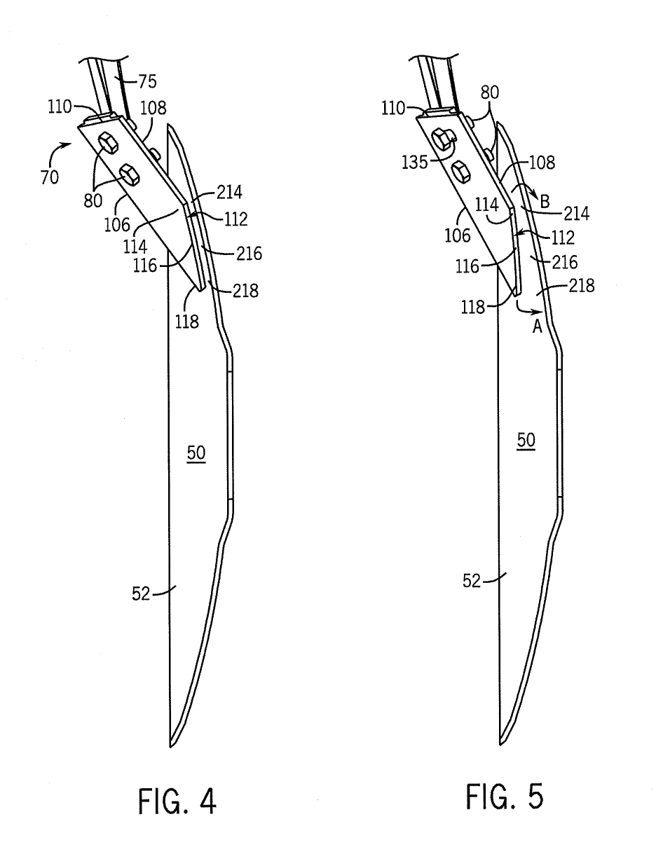

It is also apparent that since the heal segment 114 and toe segment 118 are located on opposing sides of anchoring aperture 125, a pivoting adjustment about anchoring aperture 125 causes heal 114 and toe 118 segments to actuate differently with respect to the concave surface 52 of disk 50. Accordingly, still referring to FIGS. 2 and 3, adjusting heal segment 114 toward concave surface 52, in the direction indicated as “B”, urges toe segment 118 away from concave surface 52. Adjusting heal segment 114 away from concave surface 52 urges toe segment 118 toward concave surface 52, in the direction indicated as “A.” Thus, by simultaneously shifting the heal and toe segments 114 and 118, respectively, in opposite directions, scraping edge 112 can be adjusted and nested into proper alignment with concave surface 52, such that the two are in face-to-face registration and define a clearance that has a constant width along its entire length (FIG. 4).

Referring now to FIGS. 4 and 5, each of the toe, crest, and heal segments 114, 116 and 118, respectively, of scraping edge 112 defines a respective clearance between it and the concave surface 52 of disk 50. The clearances are toe clearance 214, crest clearance 216, and heal clearance 218, respectively. Preferably, the toe, crest, and heal clearances 214, 216, and 218, respectively, are generally equal in magnitude, providing a consistent overall clearance between the scraping edge 112 and the disk concave surface 52.

The configuration of FIG. 4 shows a scraper blade 100 suitably aligned with the disk blade 50, such that the scraper edge 112 is in face-to-face registration with the disk blade 50 concave surface 52. In this configuration and proper state of alignment, the magnitudes of the toe, crest, and heal clearances 214, 216, and 218, respectively, are largely the same, whereby the opening width dimension is generally constant along the entire length of scraper edge 112. By contrast, FIG. 5 shows a relatively misaligned scraper blade 100, whereby the magnitudes of the toe, crest, and heal clearances 214, 216, and 218, respectively, are at least somewhat dissimilar. It is apparent that the misaligned scraper blade 100 in FIG. 5 can be properly aligned by rotating it in the direction labeled “A” until the scraper edge 112 is in face-to-face registration with the disk blade 50 concave surface 52.

In light of the above, to use the device, the scraper blade 100 is mounted to the disk gang 40 by way of scraper arm member 75, brackets extending from the bearing assemblies 90, the bearing shield members 95, if so equipped, and corresponding fasteners 80. Next the scraper blade 100 is positioned adjacent the respective disk blade 50, along the axial length of axle 55. The alignment is checked by observing the uniformity of the gap between the scraper blade 100 and the disk blade 50. One method of checking clearance or gap uniformity is by comparing relative values the toe, crest, and heal clearances 214, 216, and 218, respectively, between the scraper edge 112 and concave surface 52 of disk blade 50.

To the extend the magnitudes of the toe, crest, and heal clearances 214, 216, and 218, respectively, differ from each other, the scraper blade 100 is pivoted about anchoring aperture 125 until the scraper edge 112 is in face-to-face registration with the disk blade 50 concave surface 52, whereby the toe, crest, and heal clearances 214, 216, and 218, respectively, obtain approximately the same values. At that point, the scraper blade 100 and the disk blade 50 are suitably aligned. Then, the distance(s) between the scraper blade 100 and disk blade 50 can be rechecked to confirm the value(s) is within the desired parameters. If so, the fasteners 80 are tightened and the scraper blade 100 is temporarily fixed in location, position, and orientation.

While the invention has been shown and described with respect to particular embodiments, it is understood that alternatives and modifications are possible and are contemplated as being within the scope of the present invention. A wide variety of ground-engaging implements (e.g., conventional disk harrows) can employ the adjustable scraper blade system 70 of the present invention. In addition, it should be understood that the number of adjustable scraper blade systems 70 employed on the disk gang 40 is not limiting on the invention.

Many changes and modifications could be made to the invention without departing from the spirit thereof. The scope of these changes will become apparent from the appended claims.

1. An adjustable scraper blade system for use with a disk harrow having at least one disk gang, each disk gang including an axle rotatably supporting a plurality of disk blades, comprising:
a mounting bracket secured to the disc gang;
a scraper blade attached to the mounting bracket, the scraper blade having:
a leading edge, a trailing edge, and an arcuate scraping edge extending between and connecting the leading and trailing edges;
first and second faces defining a thickness:
an anchoring aperture extending between the first and second faces: and
an elongated adjustment slot extending between the first and second faces, the adjustment slot extending angularly between the leading and trailing edges;
an anchor extending through the anchoring aperture and operatively connecting the scraper blade to the mounting bracket:
a fastener extends through the adjustment slot for selectively fixing the scraper blade to the mounting bracket:
wherein the scraper blade is pivotable on the anchor about an axis perpendicular to the first face of the scraper blade thereby permitting angular alignment of the scraping edge with a concave surface of the disk blade.

2. The adjustable scraper blade system as in claim 1, wherein the disk harrow has an elongate support bracket extending parallel to the axle, supporting the mounting bracket.

3. The adjustable scraper blade system as in claim 1, wherein the disk harrow has a bearing assembly supporting the axle and the mounting bracket.

4. The adjustable scraper blade system as in claim 1, wherein the disk harrow has a bearing assembly supporting the axle and the mounting bracket and a bearing shield covering the bearing assembly and mounting the scraper blade.

5. (canceled)

6. The adjustable scraper blade system as in claim 1, wherein the scraper blade is pivotably movable with respect to the disk blade.

7. The adjustable scraper blade system as in claim 1, wherein the scraping edge defines a radius corresponding in magnitude to a radius of the concave surface of the disk blade.

8. (canceled)

9. An adjustable scraper blade system for use with a disk harrow having at least one disk gang, each disk gang including an axle with a length rotatably supporting a plurality of disk blades, comprising:
a mounting bracket secured to the disc gang; and
a scraper blade attached to the mounting bracket, the scraper blade having a leading edge, a trailing edge, an arcuate scraping edge extending between and connecting the leading and Wailing edges, and an elongate adjustment slot extending angularly between the leading and trailing edges and being generally transverse to the axle, and an anchoring aperture extending through the scraper plate and positioned between the elongate adjustment slot and the scraping edge:
an anchor extending through the anchoring aperture and operatively connecting the scraper blade to the mounting bracket: wherein:
the scraper blade is pivotable about the anchor axis thereby permitting angular alignment of the scraping edge with a concave surface of the disk blade; and
the elongate adjustment slot defines a pivotation path for adjusting the angular alignment of the scraping edge.

10. The adjustable scraper blade system as in claim 9, wherein a fastener extends through the adjustment slot, selectively fixing the scraper blade with respect to the mounting bracket.

11. The adjustable scraper blade system as in claim 9, wherein the scraper blade has a top edge extending between the leading and trailing edges, displaced from the adjustment slot.

12. The adjustable scraper blade system as in claim 11, wherein the adjustment slot extends toward a point of intersection of the top and trailing edges.

13. The adjustable scraper blade system as in claim 9, wherein the adjustment slot has an upper slot wall and a lower slot wall extending generally parallel to each other.

14. The adjustable scraper blade system as in claim 13, wherein the adjustment slot has an arcuate endwall extending between the upper and lower slot walls.

15. (canceled)

16. An adjustable scraper blade system for use with a disk harrow having at least one disk gang, each disk gang including an axle rotatably supporting a plurality of disk blades, comprising:
a mounting bracket secured to the disc gang; and
a scraper blade attached to the mounting bracket defining a thickness dimension and having:
(i) a leading edge;
(ii) a trailing edge;
(iii) an arcuate scraping edge extending between and connecting the leading and trailing edges;
(iv) an elongate adjustment slot extending through the scraper plate thickness dimension; and
(v) an anchoring aperture extending through the scraper blade thickness dimension and positioned between the elongate adjustment slot and the scraping edge, the anchoring aperture defines a pivoting axis of the scraper blade; wherein the scraper blade is pivotable about the pivoting axis thereby permitting angular alignment of the scraping edge with a concave surface of the disk blade.

17. The adjustable scraper blade system as in claim 16, wherein the anchoring aperture defines a substantially round perimeter shape.

18. (canceled)

19. The adjustable scraper blade system as in claim 16, wherein the adjustment slot has a pair of parallel sidewalls.

20. The adjustable scraper blade system as in claim 16, wherein the adjustment slot defines an arcuate perimeter shape.
